(19) United States
(12) Patent Application Publication
(10) Pub. No.: US 2021/0198448 A1
(43) Pub. Date: Jul. 1, 2021

(54) METHOD FOR PRODUCING RUBBER WET MASTERBATCH AND METHOD FOR PRODUCING RUBBER COMPOSITION

(71) Applicant: Toyo Tire Corporation, Itami-shi (JP)

(72) Inventor: Yuya Konno, Itami-shi (JP)

(73) Assignee: Toyo Tire Corporation, Itami-shi (JP)

(21) Appl. No.: 17/132,107

(22) Filed: Dec. 23, 2020

(30) Foreign Application Priority Data
Dec. 25, 2019 (JP) 2019-234673

(51) Int. Cl. C08K 5/09; C08K 3/04

(52) U.S. Cl. CPC C08K 5/09; C08K 3/04

(57) ABSTRACT

A method for producing a rubber wet masterbatch including: a step (I) of putting a rubber latex solution into a carbon black-containing slurry aqueous solution in which a carbon black is dispersed in water, without stirring the carbon black-containing slurry aqueous solution, to prepare an unmixed aqueous solution; a step (II) of mixing the unmixed aqueous solution obtained and a coagulant while the coagulant is added to the unmixed aqueous solution to produce a carbon black-containing rubber coagulum; and a step (III) of dehydrating and drying the carbon black-containing rubber coagulum obtained to produce a rubber wet masterbatch, wherein in the step (II), the coagulant is added at an addition rate of 1.5×10⁻² (mmol/min) or less per 100 g of a rubber component contained in the unmixed aqueous solution. By the method for producing a rubber wet masterbatch, vulcanized rubber having an excellent tensile product can be obtained.

### BACKGROUND OF THE INVENTION

### Field of the Invention

The present invention relates to a method for producing a rubber wet masterbatch and a method for producing a rubber composition.

### Description of the Related Art

It has been conventionally known in the rubber industry that a rubber wet masterbatch is used for improvement in the processability during the production of a rubber composition containing a carbon black and the dispersibility of a carbon black. In this method, a carbon black is mixed with a dispersion solvent in advance at a certain ratio and dispersed in the dispersion solvent by a mechanical force to obtain a carbon black-containing slurry solution, the carbon black-containing slurry solution is mixed with a rubber latex solution in a liquid phase, then, a coagulant such as an acid is added to obtain a coagulum (carbon black-containing rubber coagulum), and the coagulum is collected and dried (for example, Patent Documents 1 to 3).

In the case of using a rubber wet masterbatch, the dispersibility of the carbon black is more excellent and the obtained rubber composition is more excellent in rubber physical properties such as processability and a reinforcing property than in the case of using a rubber dry masterbatch obtained by mixing a carbon black and rubber in a solid phase. By using such a rubber composition as a raw material, it is possible to produce a rubber product (vulcanized rubber) such as a pneumatic tire having reduced rolling resistance and excellent fatigue resistance.

### PRIOR ART DOCUMENT

### Patent Document

Patent Document 1: JP-A-2016-14086
Patent Document 2: JP-A-2018-95748
Patent Document 3: JP-A-2016-160315

### SUMMARY OF THE INVENTION

In the market, tires (vulcanized rubber) in which a rubber composition is used as a raw material need to have an excellent tensile product (product of tensile strength and elongation at break).

The present invention has been made in view of the above-described circumstances, and provides a method for producing a rubber wet masterbatch with which vulcanized rubber having an excellent tensile product is obtained.

The present invention relates to a method for producing a rubber wet masterbatch, the method including: a step (I) of putting a rubber latex solution into a carbon black-containing slurry aqueous solution in which a carbon black is dispersed in water, without stirring the carbon black-containing slurry aqueous solution, to prepare an unmixed aqueous solution; a step (II) of mixing the unmixed aqueous solution obtained and a coagulant while the coagulant is added to the unmixed aqueous solution to produce a carbon black-containing rubber coagulum; and a step (III) of dehydrating and drying the carbon black-containing rubber coagulum obtained to produce a rubber wet masterbatch, wherein in the step (II), the coagulant is added at an addition rate of 1.5×10⁻² (mmol/min) or less per 100 g of a rubber component contained in the unmixed aqueous solution.

Furthermore, the present invention relates to a method for producing a rubber composition, the method including a step (IV) of dry mixing in which the rubber wet masterbatch obtained by the method for producing a rubber wet masterbatch is used.

Regarding the action mechanism of the effect in the method for producing a rubber wet masterbatch according to the present invention, some of the details are unknown and presumed as follows. However, the present invention does not need to be interpreted as being limited to this action mechanism.

The method for producing a rubber wet masterbatch according to the present invention includes: a step (I) of putting a rubber latex solution into a carbon black-containing slurry aqueous solution in which a carbon black is dispersed in water, without stirring the carbon black-containing slurry aqueous solution, to prepare an unmixed aqueous solution; a step (II) of mixing the unmixed aqueous solution obtained and a coagulant while the coagulant is added to the unmixed aqueous solution to produce a carbon black-containing rubber coagulum; and a step (III) of dehydrating and drying the carbon black-containing rubber coagulum obtained to produce a rubber wet masterbatch, wherein in the step (II), the coagulant is added at an addition rate of 1.5×10⁻² (mmol/min) or less per 100 g of a rubber component contained in the unmixed aqueous solution. An ordinary method of mixing a carbon black-containing slurry aqueous solution and a rubber latex solution, such as the method in the above-described Patent Documents, is known in which one of the solutions is put (dropped) into the other solution while the other solution is stirred, and then a coagulant is added (also referred to as conventional method). In such a conventional method, rubber latex particles to which carbon black particles are adhered are generated during the dropping and the mixing, and the sizes of the rubber latex particles are non-uniform. Furthermore, the addition of the coagulant at an uncontrolled addition rate leads to sudden coagulation. As a result, the size of the coagulum (solid crumb) cannot be controlled. In the method for producing a rubber wet masterbatch according to the present invention, the size of the coagulum (solid crumb) can be controlled to a certain size because the formation of the coagulum (solid crumb) can be gradually promoted by employing the above-described steps. Therefore, it is presumed that the tensile product is excellent in vulcanized rubber in which the rubber wet masterbatch obtained by dehydrating and drying the rubber coagulum is used.

Furthermore, in the method for producing a rubber wet masterbatch according to the present invention, the size of the coagulum (solid crumb) can be controlled so that the coagulum does not pass through a mesh filter in a solid-liquid separation step in which a vibration screen or the like is used. As a result, the yield of the rubber wet masterbatch can be increased, and the burden of treating the waste liquid that passes through the filter can be reduced.

### DETAILED DESCRIPTION OF THE PREFERRED EMBODIMENTS

### <Method for Producing Rubber Wet Masterbatch>

The method for producing a rubber wet masterbatch according to the present invention includes: a step (I) of putting a rubber latex solution into a carbon black-containing slurry aqueous solution in which a carbon black is dispersed in water, without stirring the carbon black-containing slurry aqueous solution, to prepare an unmixed aqueous solution; a step (II) of mixing the unmixed aqueous solution obtained and a coagulant while the coagulant is added to the unmixed aqueous solution to produce a carbon black-containing rubber coagulum; and a step (III) of dehydrating and drying the carbon black-containing rubber coagulum obtained to produce a rubber wet masterbatch.

### <Step (I)>

In the step (I) of the present invention, a rubber latex solution is put into a carbon black-containing slurry aqueous solution in which a carbon black is dispersed in water, without stirring the carbon black-containing slurry aqueous solution, to prepare an unmixed aqueous solution. Here, the term “without stirring” means that the solution is not artificially stirred by a disperser, a mixer, or the like described below. The unmixed aqueous solution may be prepared by putting the slurry aqueous solution into the rubber latex solution without stirring the rubber latex solution.

### <Carbon Black-Containing Slurry Aqueous Solution>

The carbon black-containing slurry aqueous solution is usually obtained by mixing a carbon black and water as raw materials.

As the carbon black, for example, a carbon black used in the ordinary rubber industry can be used, such as SAF, ISAF, HAF, FEF, or GPF. In addition, a conductive carbon black such as acetylene black or Ketjen black can be used. The carbon black may be a granulated carbon black granulated in consideration of its handleability in the ordinary rubber industry, or may be a non-granulated carbon black. The carbon blacks may be used singly or in combination of two or more kinds thereof.

The carbon black preferably has a specific surface area by nitrogen adsorption of about 30 m²/g or more and 250 m²/g or less, and more preferably about 50 m²/g or more and 200 m²/g or less.

The water is a medium containing water such as ion-exchanged water, distilled water, or industrial water as a main component, and may be, for example, water containing an organic solvent.

Examples of the method of mixing the carbon black and the water include a method of dispersing a carbon black using a general disperser such as a high shear mixer, a high shear mixer, a homomixer, a ball mill, a bead mill, a high-pressure homogenizer, an ultrasonic homogenizer, or a colloid mill. If necessary, the entire mixing system such as a disperser may be heated during mixing.

The term “high shear mixer” refers to a mixer having a rotor that is capable of high-speed rotation and a stator that is fixed. In the mixer, the rotation of the rotor with precise clearance between the rotor and the stator generates high shearing action. As such a high shear mixer, commercially available products can be used, such as “High Shear Mixer” manufactured by SILVERSON, “High Shear Mixer IKA 2000 Series” manufactured by IKA, “T.K. HOMO MIXER” manufactured by Tokushu Kika Kogyo Co., Ltd., “Ultra Homo Mixer” manufactured by MIZUHO INDUSTRIAL CO., LTD., “CLEARMIX” manufactured by M Technique Co., Ltd., and “CAVITRON” manufactured by Pacific Machinery & Engineering Co., Ltd.

The rate of the carbon black in the carbon black-containing slurry aqueous solution is preferably 1 to 20% by mass. The rate of the carbon black in the carbon black-containing slurry aqueous solution is more preferably 2% by mass or more, and still more preferably 5% by mass or more, from the viewpoint of enhancing the work efficiency of removing water in the step of dehydrating and drying. The rate of the carbon black in the carbon black-containing slurry aqueous solution is more preferably 15% by mass or less, and still more preferably 12% by mass or less, from the viewpoint of reducing the viscosity of the carbon black-containing slurry aqueous solution to enhance the stirring efficiency.

### <Rubber Latex Solution>

As the rubber latex solution, a natural rubber latex solution and a synthetic rubber latex solution can be used.

The natural rubber latex solution is a natural product due to the metabolic action of a plant, and is particularly preferably a natural rubber/water-based solution containing water as a dispersion solvent. The number average molecular weight of the natural rubber contained in the natural rubber latex is preferably 2,000,000 or more, and more preferably 2,500,000 or more. In the natural rubber latex solution, latex such as concentrated latex and fresh latex called field latex can be used without distinction. Examples of the synthetic rubber latex solution include solutions produced by emulsion polymerization of styrene-butadiene rubber, butadiene rubber, nitrile rubber, and chloroprene rubber. The rubber latex solutions may be used singly or in combination of two or more kinds thereof.

The rate of the rubber component (solid content) in the rubber latex solution is preferably 15 to 35% by mass. The rate of the rubber component (solid content) in the rubber latex solution is more preferably 18% by mass or more, and still more preferably 20% by mass or more, from the viewpoint of the reactivity between the carbon black and the rubber content in the latex. The rate of the rubber component (solid content) in the rubber latex solution is more preferably 33% by mass or less, and still more preferably 30% by mass or less, from the viewpoint of preventing a decrease in stirring efficiency due to the high viscosity.

The content of the carbon black is preferably 10 to 120 parts by mass per 100 parts by mass of the rubber component in the rubber latex. The content of the carbon black is preferably 20 parts by mass or more, more preferably 30 parts by mass or more, and preferably 100 parts by mass or less, more preferably 80 parts by mass or less per 100 parts by mass of the rubber component in the rubber latex, from the viewpoint of improving the reinforcing property of the vulcanized rubber.

### <Step (II)>

In the step (II) of the present invention, the unmixed aqueous solution obtained above and a coagulant are mixed while the coagulant is added to the unmixed aqueous solution to produce a carbon black-containing rubber coagulum. As the coagulant, a coagulant usually used for coagulation of a rubber latex solution can be used. Examples of the coagulant include acids such as formic acid and sulfuric acid; and bases such as sodium chloride.

In the step (II), the addition rate of the coagulant is 1.5×10⁻² (mmol/min) or less per 100 g of the rubber component contained in the unmixed aqueous solution. The addition rate of the coagulant is preferably 1.2×10⁻² (mmol/min) or less, and more preferably 1.0×10⁻² (mmol/min) or less per 100 g of the rubber component contained in the unmixed aqueous solution from the viewpoint of improving the tensile product of the crosslinked rubber. Furthermore, the addition rate is preferably 1.0×10⁻⁵ (mmol/min) or more, more preferably 1.0×10⁻⁴ (mmol/min) or more, and still more preferably 1.0×10⁻³ (mmol/min) or more per 100 g of the rubber component contained in the unmixed aqueous solution from the viewpoints of improving the tensile product of the crosslinked rubber and enhancing the productivity.

In the step (II), the method of mixing is not particularly limited, and examples of the method include a method of mixing using a general disperser such as a high shear mixer, a high shear mixer, a homomixer, a ball mill, a bead mill, a high-pressure homogenizer, an ultrasonic homogenizer, or a colloid mill or a mixer in which a blade rotates in a cylindrical container. If necessary, the entire mixing system such as a disperser may be heated during mixing.

It is sufficient that the unmixed aqueous solution and the coagulant is mixed by the disperser or the mixer. For example, the peripheral speed of the stirring blade is preferably 20 m/s or less, and more preferably 10 m/s or less from the viewpoint of improving the tensile product of the crosslinked rubber.

### <Step (III)>

In the step (III) of the present invention, the carbon black-containing rubber coagulum obtained above is dehydrated and dried to produce a rubber wet masterbatch. In the method of dehydrating and drying, various dehydration/drying devices can be used, such as a single-screw extruder, a twin-screw extruder, an oven, a conveyor dryer, a vacuum dryer, and an air dryer. If necessary, prior to the step (III), a step may be provided, such as a centrifugation step or a solid-liquid separation step in which a vibration screen is used, for the purpose of, for example, appropriately reducing the amount of water contained in the carbon black-containing rubber coagulum, or a step may be provided, such as a cleaning step by a water washing method or the like, for the purpose of cleaning.

The solid-liquid separation step in which a vibration screen is used is a step of separating the granularly formed carbon black-containing rubber coagulum by filtration using a known filter. The filtration may be performed by a batch method or a continuous method. Examples of the continuous method include a method in which an inclined mesh filter is provided, a mixture of a water-containing coagulum obtained in a coagulation step is supplied to the upper side of the inclined filter while the filter is vibrated, and the coagulum from which water is separated is taken out on the lower side of the inclined filter.

### <Step (IV)>

The method for producing a rubber composition according to the present invention includes a step (IV) of dry mixing in which the rubber wet masterbatch obtained above is used.

In the step (IV), various compounding agents can be further used. For example, compounding agents for ordinary use in the rubber industry can be used, such as rubber, sulfur-based vulcanizing agents, vulcanization accelerators, anti-aging agents, silica, silane coupling agents, zinc oxide, methylene acceptors and methylene donors, stearic acid, vulcanization activators, vulcanization retarders, organic peroxides, softeners such as waxes and oils, and processing aids. If necessary, the various compounding agents can also be used for production of the rubber wet masterbatch.

The above-described rubber is used separately from the rubber component derived from the rubber wet masterbatch. Examples of the rubber include natural rubber (NR) and diene-based synthetic rubber such as isoprene rubber (IR), styrene-butadiene rubber (SBR), butadiene rubber (BR), chloroprene rubber (CR), and nitrile rubber (NBR). The rubber may be used singly or in combination of two or more kinds thereof.

The content of the carbon black is preferably 10 to 120 parts by mass per 100 parts by mass of the rubber component in the rubber composition. The content of the carbon black is preferably 20 parts by mass or more, more preferably 30 parts by mass or more, and preferably 100 parts by mass or less, more preferably 80 parts by mass or less per 100 parts by mass of the rubber component in the rubber composition, from the viewpoint of improving the reinforcing property of the vulcanized rubber.

The sulfur as the sulfur-based vulcanizing agent may be ordinary sulfur for rubber, and sulfur such as powdered sulfur, precipitated sulfur, insoluble sulfur, and highly dispersible sulfur can be used. The sulfur-based vulcanizing agents may be used singly or in combination of two or more kinds thereof.

The content of the sulfur is preferably 0.3 to 6.5 parts by mass per 100 parts by mass of the rubber component in the rubber composition. If the content of the sulfur is less than 0.3 parts by mass, the crosslink density of the vulcanized rubber is insufficient and the rubber strength or the like is deteriorated. If the content is more than 6.5 parts by mass, both the heat resistance and the durability are particularly deteriorated. In order to ensure good rubber strength of the vulcanized rubber and further improve the heat resistance and the durability, the content of the sulfur is preferably 1.0 to 5.5 parts by mass per 100 parts by mass of the rubber component in the rubber composition.

An ordinary vulcanization accelerator for rubber is sufficient as the vulcanization accelerator, and examples of the vulcanization accelerator include sulfenamide-based vulcanization accelerators, thiuram-based vulcanization accelerators, thiazole-based vulcanization accelerators, thiourea-based vulcanization accelerators, guanidine-based vulcanization accelerators, and dithiocarbamate-based vulcanization accelerators. The vulcanization accelerators may be used singly or in combination of two or more kinds thereof.

The content of the vulcanization accelerator is preferably 1 to 5 parts by mass per 100 parts by mass of the rubber component in the rubber composition.

An ordinary anti-aging agent for rubber is sufficient as the anti-aging agent, and examples of the anti-aging agent include aromatic amine-based anti-aging agents, amine-ketone-based anti-aging agents, monophenol-based anti-aging agents, bisphenol-based anti-aging agents, polyphenol-based anti-aging agents, dithiocarbamate-based anti-aging agents, and thiourea-based anti-aging agents. The anti-aging agents may be used singly or in combination of two or more kinds thereof.

The content of the anti-aging agent is preferably 1 to 5 parts by mass per 100 parts by mass of the rubber component in the rubber composition.

In the step (IV), the method of blending (adding) the rubber wet masterbatch and the various compounding agents is, for example, a method of kneading with a kneader used in the ordinary rubber industry, such as a Banbury mixer, a kneader, or a roll.

The method of kneading is not particularly limited, and examples of the method include a method of adding and kneading components other than vulcanizing components such as sulfur-based vulcanizing agents and vulcanization accelerators in an arbitrary order, a method of adding and kneading components other than vulcanizing components simultaneously, and a method of adding and kneading all components simultaneously. The number of times of the kneading may be one or more. The kneading time depends on the size of the kneader used, and a time of about 2 to 5 minutes is usually sufficient as the kneading time. The discharge temperature of the kneader is preferably 120 to 170° C., and more preferably 120 to 150° C. In the case where the vulcanizing component is contained, the discharge temperature of the kneader is preferably 80 to 110° C., and more preferably 80 to 100° C.

According to the method for producing a rubber wet masterbatch or the method for producing a rubber composition of the present invention, vulcanized rubber having an excellent tensile product can be obtained. The rubber wet masterbatch and the rubber composition according to the present invention are suitable for a pneumatic tire.

### EXAMPLES

The present invention is described below with reference to Examples, but the present invention is not limited to these Examples.

### (Raw Materials Used)

a) Natural rubber latex solution: “NR Field Latex” (manufactured by Golden Hope Plantations Berhad) (DRC=31.2%)

b) Carbon Black: “SEAST KH” (manufactured by Toyo Carbon Co., Ltd.)

c) Zinc oxide: “Zinc Oxide No. 1” (manufactured by MITSUI MINING & SMELTING CO., LTD.)

d) Stearic acid: “LUNAC S20” (manufactured by Kao Corporation)

e) Anti-aging agent: “NOCRAC 6C” (manufactured by OUCHI SHINKO CHEMICAL INDUSTRIAL CO., LTD.)

f) Wax: “OZOACE 0355” (manufactured by NIPPON SEIRO CO., LTD.)

g) Sulfur: “Fine Powder Sulfur with 5% Oil” (manufactured by Tsurumi Chemical Industry Co., ltd.)

h) Vulcanization accelerator: “NOCCELER NS-P” (manufactured by OUCHI SHINKO CHEMICAL INDUSTRIAL CO., LTD.)

### Example 1

### <Step (I): Preparation of Unmixed Aqueous Solution>

Water was added to the natural rubber latex solution “NR Field Latex” at room temperature to prepare a rubber latex solution having a concentration of 25% by mass. Separately, the carbon black was added to water and dispersed in the water using “High Shear Mixer” manufactured by SILVERSON (conditions: 9,000 rpm, 30 minutes) to prepare a carbon black-containing slurry aqueous solution having a carbon black concentration of 6% by mass. Next, the rubber latex solution (25% by mass) was put into the carbon black-containing slurry aqueous solution at room temperature without stirring the slurry aqueous solution so that the solid content (rubber component) was 100 parts by mass per 50 parts by mass of the carbon black to prepare an unmixed aqueous solution.

### <Step (II): Production of Carbon Black-Containing Rubber Coagulum>

Next, to the unmixed aqueous solution (90° C.) prepared in the step (I), formic acid (10% solution) was added as a coagulant at an addition rate of 9.1×10⁻⁴ (mmol/min) per 100 g of the rubber component contained in the unmixed aqueous solution while the solution was stirred by a stirring blade having a peripheral speed of 10 m/s until the pH of the entire solution reached 4 to produce a mixture containing a carbon black-containing rubber coagulum and a coagulating liquid. The addition rate of the coagulant is a value calculated in terms of formic acid (100%). The size of the obtained carbon black-containing rubber coagulum was calculated by the following formula and found to be 2 mm.

Formula: size of carbon black-containing rubber coagulum (mm)=(R1×V1+R2×V2+ . . . +Rk×Vk) [Rk represents the equivalent circle diameter (mm) of each carbon black-containing rubber coagulum (mm); Vk represents the volume ratio (%) of the carbon black-containing rubber coagulum having each size.]

For example, in the case where a carbon black-containing rubber coagulum is obtained in which the ratio of the coagulum having an equivalent circle diameter of 5 mm is 20 vol %, the ratio of 15 mm is 30 vol %, the ratio of 25 mm is 40 vol %, and the ratio of 35 mm is 10 vol %, the size of the carbon black-containing rubber coagulum is 19 (mm) {=(5×20+15×30+25×40+35×10)/100)}.

### <Step (III): Production of Rubber Wet Masterbatch>

The mixture containing the carbon black-containing rubber coagulum and the coagulating liquid produced in the step (II) was discharged from the mixer to a 40 mesh filter and subjected to a solid-liquid separation treatment, and then resulting coagulum was dehydrated and dried with a squeezer type single-screw extrusion dehydrator (screw press No. V-02 manufactured by SUEHIRO EPM CORPORATION) to produce a rubber wet masterbatch. The yield (%) of the rubber wet masterbatch was calculated by the following formula and found to be 97%. Formula: yield of rubber wet masterbatch (%)=mass of obtained rubber wet masterbatch/mass of charged solid

### <Step (IV): Production of Rubber Composition and Unvulcanized Rubber Composition>

The rubber wet masterbatch obtained above and raw materials shown in Table 1 (components other than the sulfur and the vulcanization accelerator) were dry-mixed using a Banbury mixer (kneading time: 3 minutes, discharge temperature: 150° C.) to produce a rubber composition. Next, the sulfur and the vulcanization accelerator shown in Table 1 were added to the obtained rubber composition, and the resulting mixture was dry-mixed using a Banbury mixer (kneading time: 1 minute, discharge temperature: 90° C.) to produce an unvulcanized rubber composition. The blending ratio in Table 1 is shown by the mass by part (phr) per 100 parts by mass of the total amount of the rubber components contained in the rubber composition.

### Examples 2 to 8 and Comparative Examples 3 to 4

Rubber wet masterbatches, rubber compositions, and unvulcanized rubber compositions in Examples 2 to 8 were produced in the same manner as in Example 1 except that in <Step (II): production of carbon black-containing rubber coagulum> in Example 1, the addition rate (mmol/min) of the coagulant and the peripheral speed (m/s) of the stirring blade were changed to the values shown in Table 1. Table 1 shows the results of the size (mm) of the carbon black-containing rubber coagulum and the yield (%) of the rubber wet masterbatch in each Example.

### Comparison Example 1

A rubber wet masterbatch, a rubber composition, and an unvulcanized rubber composition in Comparative Example 1 were produced in the same manner as in Example 1 except that in <Step (II): production of carbon black-containing rubber coagulum> in Example 1, after mixing the unmixed aqueous solution for a certain time, formic acid (10% solution) was added as a coagulant not at a certain rate but at a time. Table 1 shows the results of the size (mm) of the carbon black-containing rubber coagulum and the yield (%) of the rubber wet masterbatch.

### Comparative Example 2

A rubber wet masterbatch, a rubber composition, and an unvulcanized rubber composition in Comparative Example 2 were produced in the same manner as in Example 1 except that in <Step (II): production of carbon black-containing rubber coagulum> in Example 1, after mixing the unmixed aqueous solution for a certain time, formic acid (10% solution) was added as a coagulant not at a certain rate but at a time, and that the peripheral speed (m/s) of the stirring blade was changed to the value shown in Table 1. Table 1 shows the results of the size (mm) of the carbon black-containing rubber coagulum and the yield (%) of the rubber wet masterbatch.

The unvulcanized rubber compositions obtained in Examples and Comparative Examples described above were vulcanized at 150° C. for 30 minutes to produce vulcanized rubber. The obtained vulcanized rubber was evaluated as follows. Table 1 shows the evaluation results.

### <Evaluation of Tensile Product>

The obtained vulcanized rubber was punched into the dumbbell shape No. 3 to prepare a sample, the sample was subjected to a tensile test in accordance with JIS K6251, the tensile product (TB (tensile strength)×EB (elongation at break)) was determined as the breaking property, and the index based on the value in Comparative Example 1 set to 100 was displayed to evaluate the tensile product. The larger the value is, the better the tensile product is.

TABLE 1

| | | Compara- | Compara- | Compara- | Compara- | | | | | | | | |
|---|---|---|---|---|---|---|---|---|---|---|---|---|---|
| | | tive | tive | tive | tive | Ex- | Ex- | Ex- | Ex- | Ex- | Ex- | Ex- | Ex- |
| | | Example | Example | Example | Example | ample | ample | ample | ample | ample | ample | ample | ample |
| | | 1 | 2 | 3 | 4 | 1 | 2 | 3 | 4 | 5 | 6 | 7 | 8 |
| Steps | Rubber latex | 100 | 100 | 100 | 100 | 100 | 100 | 100 | 100 | 100 | 100 | 100 | 100 |
| (I) to | solution | | | | | | | | | | | | |
| (III) | (solid content) | | | | | | | | | | | | |
| | Carbon black- | 50 | 50 | 50 | 50 | 50 | 50 | 50 | 50 | 50 | 50 | 50 | 50 |
| | containing | | | | | | | | | | | | |
| | slurry aqueous | | | | | | | | | | | | |
| | solution | | | | | | | | | | | | |
| | (solid content) | | | | | | | | | | | | |
| | Addition rate of | — | — | 1.6 × | 1.6 × | 9.1 × | 2.8 × | 9.1 × | 1.4 × | 9.1 × | 2.8 × | 9.1 × | 1.4 × |
| | coagulant per | | | 10⁻² | 10⁻² | 10⁻⁴ | 10⁻³ | 10⁻³ | 10⁻² | 10⁻⁴ | 10⁻³ | 10⁻³ | 10⁻² |
| | 100 g of rubber | | | | | | | | | | | | |
| | component | | | | | | | | | | | | |
| | (mmol/min) | | | | | | | | | | | | |
| | Peripheral speed | 10 | 15 | 10 | 15 | 10 | 10 | 10 | 10 | 7 | 7 | 7 | 7 |
| | of stirring | | | | | | | | | | | | |
| | blade (m/s) | | | | | | | | | | | | |
| | Size of carbon | 1 | <1 | 25 | 80 | 2 | 5 | 15 | 18 | 25 | 35 | 40 | 60 |
| | black-containing | | | | | | | | | | | | |
| | rubber coagulum | | | | | | | | | | | | |
| | (mm) | | | | | | | | | | | | |
| | Yield of rubber | 95 | 91 | 94 | 92 | 97 | 98 | 98 | 96 | 98 | 99 | 99 | 98 |
| | wet masterbatch | | | | | | | | | | | | |
| | (%) | | | | | | | | | | | | |
| | Zinc oxide | 3 | 3 | 3 | 3 | 3 | 3 | 3 | 3 | 3 | 3 | 3 | 3 |
| | Stearic acid | 2 | 2 | 2 | 2 | 2 | 2 | 2 | 2 | 2 | 2 | 2 | 2 |
| | Anti-aging agent | 2 | 2 | 2 | 2 | 2 | 2 | 2 | 2 | 2 | 2 | 2 | 2 |
| | Wax | 2 | 2 | 2 | 2 | 2 | 2 | 2 | 2 | 2 | 2 | 2 | 2 |
| | Sulfur | 2 | 2 | 2 | 2 | 2 | 2 | 2 | 2 | 2 | 2 | 2 | 2 |
| | Vulcanization | 2 | 2 | 2 | 2 | 2 | 2 | 2 | 2 | 2 | 2 | 2 | 2 |
| | accelerator | | | | | | | | | | | | |
| Evaluation | Tensile product | 100 | 97 | 98 | 99 | 102 | 103 | 103 | 101 | 102 | 104 | 103 | 103 |

What is claimed is:

1. A method for producing a rubber wet masterbatch, the method comprising:
a step (I) of putting a rubber latex solution into a carbon black-containing slurry aqueous solution in which a carbon black is dispersed in water, without stirring the carbon black-containing slurry aqueous solution, to prepare an unmixed aqueous solution;
a step (II) of mixing the unmixed aqueous solution obtained and a coagulant while the coagulant is added to the unmixed aqueous solution to produce a carbon black-containing rubber coagulum; and
a step (III) of dehydrating and drying the carbon black-containing rubber coagulum obtained to produce a rubber wet masterbatch,
wherein in the step (II), the coagulant is added at an addition rate of 1.5×10⁻² (mmol/min) or less per 100 g of a rubber component contained in the unmixed aqueous solution.

2. A method for producing a rubber composition, the method comprising a step (IV) of dry mixing in which the rubber wet masterbatch obtained by the method for producing a rubber wet masterbatch according to claim 1 is used.
